(19) United States
(12) Patent Application Publication
(10) Pub. No.: US 2008/0105174 A1
(43) Pub. Date: May 8, 2008

(54) Assembly of a Vault and Sealable Flexible Valuables Containers to be Used Therewith

(76) Inventors: Frans Wijnveld, Aerdenhout (NL); Sander De Ridder, Al Loenen Aan De Vecht (NL)

Correspondence Address: HARNESS, DICKEY & PIERCE, P.L.C., P.O. BOX 8910, RESTON, VA, 20195, US

(21) Appl. No.: 11/547,033

(22) PCT Filed: Apr. 4, 2005
(86) PCT No.: PCT/NL05/00245

§ 371 Date: Jan. 18, 2008

(30) Foreign Application Priority Data
Apr. 2, 2004 (NL) 1025869

(51) Int. Cl. E05G 1/024

(52) U.S. Cl. 109/50

(57) ABSTRACT

The invention relates to an assembly of at least one vault, comprising walls bounding an internal space, and a feed opening to the internal space, a number of sealable valuables containers which are each provided with a radio frequency identification element (RFID element) and radio frequency detection means, wherein the valuables containers are flexible valuables containers or seal bags, and at least one antenna connected to the detection means for generating a radio frequency field in the internal space is disposed in the internal space at a distance from the walls.

The invention relates to an assembly of at least one vault, comprising walls bounding an internal space, and a feed opening to the internal space, a number of sealable valuables containers which are each provided with a radio frequency identification element (RFID element) and radio frequency detection means.

With such an assembly it is possible to have goods of value, such as money, transferred unguarded by people from for instance a company premises to a bank, where the vault is arranged. The feed opening connects onto an opening in the wall of the bank, which is of course provided with a suitable closure such as a door.

A radio frequency identification element (RFID element) transmits an identification code. This code can be detected by the radio frequency detection means and further processed in processing means.

An RFID element can be battery-powered, but in the present application an RFID element embodied as a transponder is preferably used, wherein operating voltage is obtained when a tuned circuit forming part of the element is excited in a suitable radio frequency field. Suitable per se known RFID elements can optionally be programmable. The identification code can be set in the case of programmable elements, while a code set during manufacture is generated in non-programmable RFID elements.

Using the code the valuables container provided with the relevant RFID element can be identified unambiguously.

An assembly of the present type is therefore used to enable a valuables container to be deposited in safe manner at a bank, wherein it is possible to record, without human intervention, the time at which a specific valuables container is deposited in the vault.

In a known assembly of the present type the valuables containers are embodied as cases, wherein the RFID elements are arranged at a precisely predetermined location in an upper surface of these cases. The internal space of the associated vault is embodied such that the case is accurately positioned when it is placed in the internal space via the feed opening. In this position the RFID element is situated directly below a coil or the like of the radio frequency detection means, so that the RFID element can be read. After reading, the case is transported further into the internal space, so that a subsequent case can be placed in the vault via the feed opening.

Plastic envelopes intended for once-only use are nowadays much used as sealable valuables containers. After being closed, such security envelopes cannot be opened without damage. The envelopes are provided with a unique number, which can for instance be arranged by means of a barcode. Human intervention is in principle necessary to record depositing of such a security envelope. Because the envelope is not form-retaining, may have a greater or smaller thickness and can be inserted in different ways into the feed opening of a vault, it is not possible to ensure that the barcode of every inserted security envelope can be read. This could result in a dispute between the depositor of the envelope and the vault administrator concerning the question of whether an envelope, if it is not found by the vault administrator, has really been placed in the vault by the depositor.

The invention has for its object to provide an assembly of the type specified in the preamble which obviates these drawbacks.

This is achieved according to the invention with an assembly wherein the valuables containers are flexible valuables containers provided with an RFID element, and wherein at least one antenna connected to detection means for generating a radio frequency field in the internal space of the vault is disposed in the internal space at a distance from the walls. A radio frequency field can hereby be generated in almost the whole internal space with a sufficient degree of homogeneity to enable detection in reliable manner of every RFID element situated in the internal space. It is therefore no longer necessary for the RFID element to be positioned in a precisely predetermined location in the internal space for the purpose of detection.

According to a further advantageous embodiment, the internal space of the vault is provided with at least one auxiliary wall which is transparent to radio frequency radiation from the radio frequency field and which is arranged at a distance from the walls of the internal space of the vault. Even when the RFID element of a flexible valuables container lies at a very unfavourable position directly against a wall of the internal space, detection thereof will still be possible with great reliability because the radio frequency field, also at the position of the auxiliary wall against which the element then lies, has an unchanged field strength since the field extends through the auxiliary wall.

A further suitable development is characterized in claim 3. The more the auxiliary wall is situated at a position where the flexible valuables containers will usually move against it or move closely along it, it is possible in this manner to detect the RFID element of each container with great certainty.

The measure of claim 4 is preferably applied. Each valuables container will slide over the guide wall, and therefore over the auxiliary wall, after being placed in the vault through the feed opening. The RFID element of the relevant flexible valuables container herein moves in certain manner through the substantially uniform radio frequency field.

The radio frequency field can have a considerable magnitude, thereby creating a great insensitivity to the position and manner in which the flexible container is dropped into the feed opening, by applying the measure of claim 5. A uniform field will be set over practically the full width of the auxiliary wall.

A suitable embodiment is characterized in claim 6.

Applying the measure of claim 7 further ensures that when a flexible valuables container is inserted the RFID element will be reliably situated within the generated radio frequency field so as to enable certain detection.

The invention will be further elucidated in the following description with reference to the annexed figures.

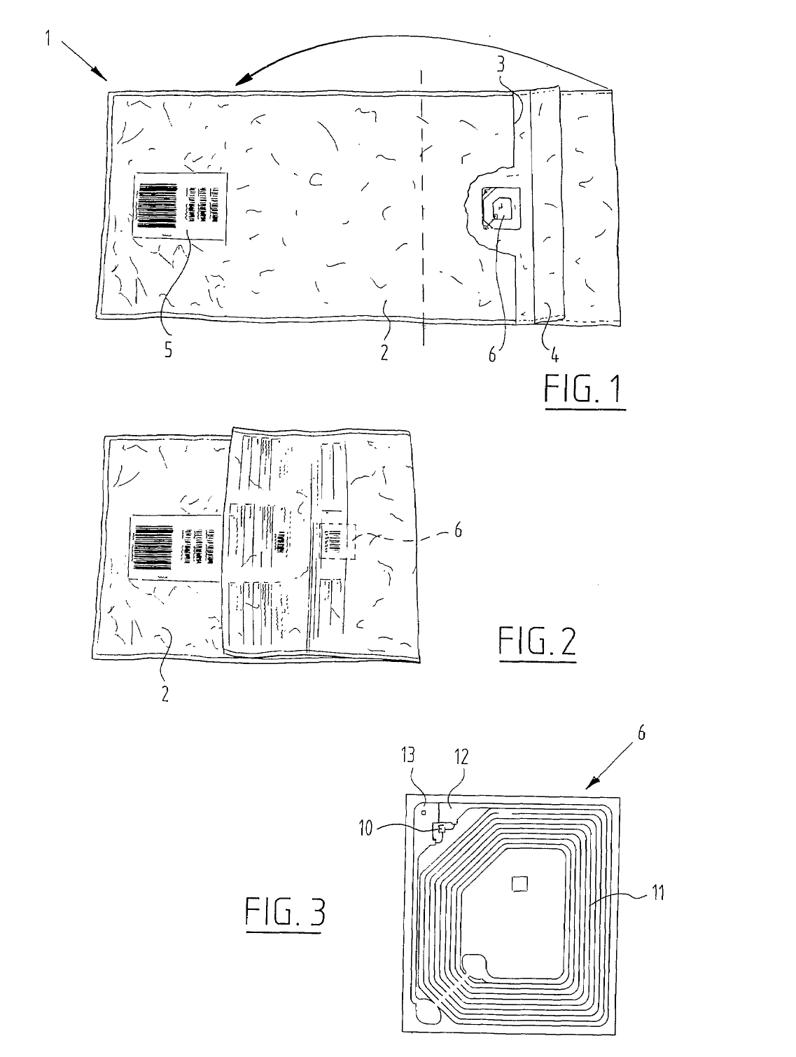

FIG. 1 shows a top view of a flexible valuables container according to the invention in the form of an envelope.

FIG. 2 shows the valuables container of FIG. 1 in the closed position.

FIG. 3 shows an RFID element as applied in the flexible valuables container of FIGS. 1 and 2.

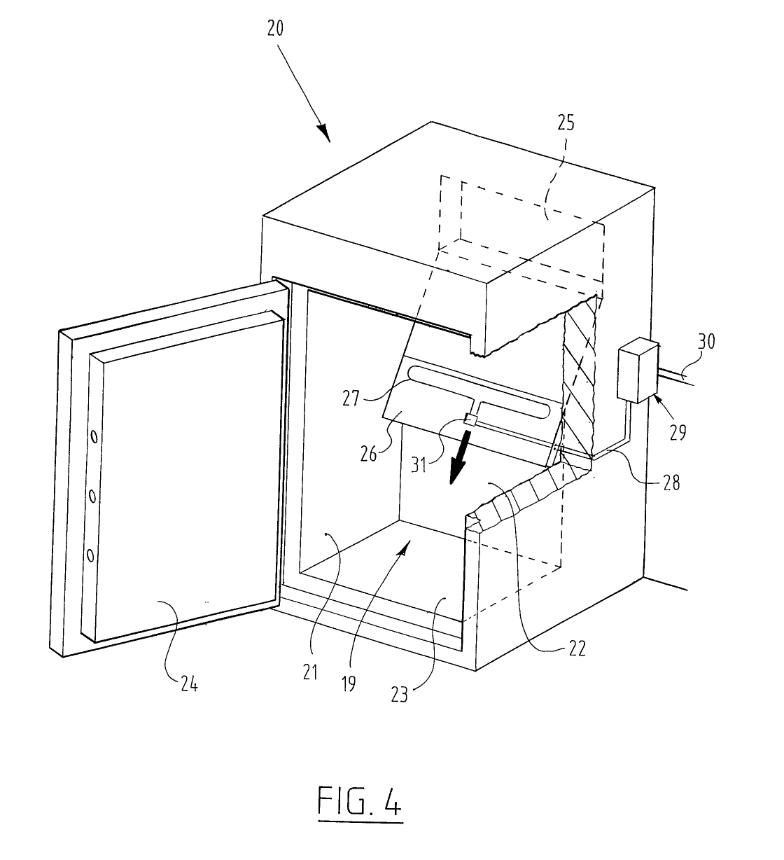

FIG. 4 is a partly schematic, perspective view of a vault of an assembly according to a preferred embodiment of the invention.

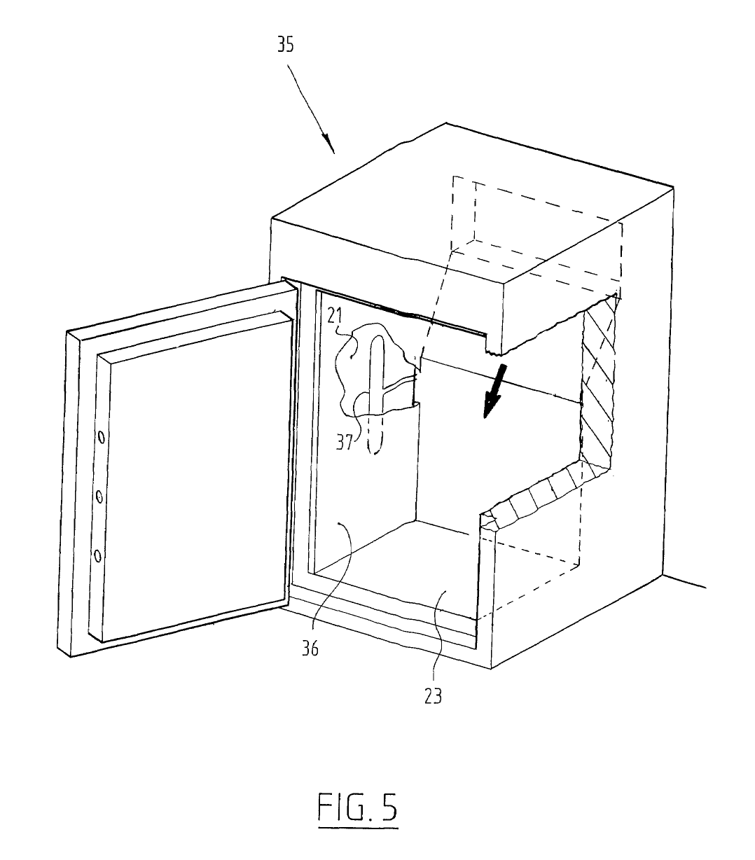

FIG. 5 shows a view corresponding to FIG. 4 of another embodiment of a vault of the assembly according to the invention.

The flexible valuables container shown in FIG. 1 of the exemplary embodiment of the assembly according to the invention is an envelope 2 with flat sides. The envelope has an opening 3 through which valuable objects, and in particular money, can be placed in envelope 3. As soon as the envelope is filled, it can be closed with flap 4. This flap is provided with an adhesive layer initially covered with a protective strip. After removal of the protective strip the flap can be folded over and adhered. The type of glue is chosen here such that strip 4 cannot be opened without being damaged.

Valuables container 1 comprises a label 5 which in this exemplary embodiment comprises a unique identification code with corresponding barcode.

The flexible valuables container further comprises an RFID element which is arranged on the inner side of a flat side of an envelope at a distance from the edges thereof. The choice of this position achieves that the RFID element will at all times occupy a relatively central position in the vault to be further discussed, thereby ensuring detection.

An example of an RFID element to be used with the valuables container according to the invention is shown in FIG. 3.

This element, which is per se commercially available, is arranged on a flexible adhesive foil, whereby the element can be adhered to the inside of the envelope. An integrated circuit 10 is arranged on the flexible foil. Further arranged on the foil is a flexible printed circuitry in the form of a coil or antenna 11. The two ends of coil 12, 13 are connected galvanically to associated connecting elements of integrated circuit 10.

When this element 6 now enters a radio frequency field with a frequency for which the coil 11 is tuned, this will result in an electrical alternating voltage at the ends 12, 13 which serves as supply voltage for integrated circuit 10. The integrated circuit is designed such that, when an alternating voltage is applied thereto, a digital signal is generated and transmitted by means of the coil. This digital signal comprises a unique identification code stored in the integrated circuit.

The transmitted digital signal can be detected by suitable means, which will be further described, so that it is possible to establish which code is stored in the RFID element or which code is associated with the relevant flexible valuables container.

FIG. 4 shows a vault with a suitable embodiment for the assembly according to the invention. Vault 20 has an internal space 19 which is bounded by side walls 21, 22, a bottom wall 23 and, in this case, a door 24. Formed in one of the side walls is a feed opening 25 through which the above discussed valuables containers can be deposited in the vault to remain there for safe-keeping until they can be removed from the vault by a bank employee or the like.

A guide wall extends obliquely downward from feed opening 25. The valuables container inserted into the vault via the feed opening slide downward along this guide wall.

A part of the guide wall is formed by an auxiliary wall 26 which is manufactured from material which is transparent to radio frequency radiation from the radio frequency field which is generated in a manner to be described further for the purpose of detecting the RFID element. This auxiliary wall can for instance be manufactured from a plastic.

Arranged on this auxiliary wall 26 is an antenna 27 which has a loop shape and extends over at least practically the full width of auxiliary wall 26. Antenna 27 is connected to an electronic circuit which provides the power supply to the antenna, and this circuit 31 is connected via a connecting line 28 to processing means of detection means 29.

Detection means 29, which thus also comprise antenna 27 and circuit 31 in addition to the processing means, is further provided with a connection 30 to a PC with which the detected data can be recorded and optionally further processed.

Because antenna 26 is arranged on the transparent auxiliary wall 26, the radio frequency field generated by antenna 27 will extend unimpeded through the auxiliary wall and therefore have a desired homogeneity at the position of this auxiliary wall. It will hereby be possible to readily detect an RFID element moving along close to this wall.

The form of antenna 27 can vary greatly in accordance with the conditions, and will substantially be determined experimentally. Instead of the narrow loop form shown here, the antenna can also have a wide loop shape, and extend for instance along the edges of auxiliary wall 26.

The vault 35 shown in FIG. 5 is provided in its internal space with an auxiliary wall 36 which extends a certain distance from the walls 21, 23 of the internal space of the vault. Auxiliary wall 36 thus forms a slightly smaller internal space where the inserted valuables containers are collected.

The material of the double wall 36 is likewise transparent to the radio frequency radiation of the radio frequency field. This field will thus be able to extend through this double wall, so that RFID elements of the inserted valuables containers situated at the most unfavourable positions, i.e. those lying against the walls, still lie in a good homogenous field and therefore function properly and can be detected.

In the embodiment shown here, antenna 37 is arranged over a large area against the double wall transparent to the relevant radio frequency radiation. A more or less homogeneous field is thus generated in the whole internal space, whereby all RFID elements situated inside this internal space can be excited.

It will be apparent that a number of RFID elements will thus be able to transmit a code simultaneously, but with a suitable programming of the processing means it is possible in simple manner to separate these different signals from each other.

In the embodiment of FIG. 4, substantially only an RFID element of a valuables container sliding over auxiliary wall 26 will be detected, and previously inserted valuables container already situated in the internal space will either not be detected, or will be detected with a less strong signal.

The invention is not limited to the embodiments shown in the figures. The flexible valuables containers can thus be embodied in many different ways. The vault of the assembly according to the invention can also be embodied in many different ways. What is important is that the antenna is positioned and dimensioned such that a substantially homogeneous radio frequency field is set over a considerable part of the internal space. It is important here that inserted flexible valuables containers pass with certainty through the area over which this field is set.

With the assembly according to the invention it is thus possible to record the moment at which a determined valuables container is placed in the vault. The depositor will document the transport of the valuables container as far as the vault, and the vault administrator, in particular the bank, will document the presence of the container in the vault. An uninterrupted monitoring of the presence of the valuables container is thus possible, which makes unlawful actions in respect of the container very difficult indeed, if not impossible.

Two-way systems also fall within the context of the invention. These are systems wherein flexible valuables containers provided with an RFID element can be both deposited in and removed from the vault. The radio frequency detection means herein detect and record which containers move in and out of the vault.

Systems moreover fall within the context of the invention wherein the internal space of the vault is movable and contains for instance a number of compartments. The antenna can be mounted on the moving elements or on the wall of the vault.

1. Assembly of at least one vault, comprising:
walls bounding an internal space;
a feed opening to the internal space;
a number of sealable valuables containers, each provided with a radio frequency identification element (RFID element); and
radio frequency detection means, connected to at least one antenna, for generating a radio frequency field in the internal space, the valuables containers being flexible valuables containers or seal bags, and the internal space being provided with at least one auxiliary wall which is transparent to radio frequency radiation from the radio frequency field and which is arranged at a distance from the walls.

2. Assembly as claimed in claim 1, wherein the antenna is arranged on the auxiliary wall.

3. Assembly as claimed in claim 1, wherein the auxiliary wall forms at least a part of a guide wall extending obliquely downward from the feed opening.

4. Assembly as claimed in claim 1, wherein the antenna has a loop shape and extends over at least practically the full width of the auxiliary wall.

5. Assembly as claimed in claim 1, wherein the antenna is formed by printed circuitry on a printed circuit board.

6. Assembly as claimed in claim 1, wherein the valuables containers are envelopes with flat sides and the RFID element is arranged on the inner side of a flat side at a distance from the edges thereof.

7. (canceled)

8. Assembly as claimed in claim 2, wherein the auxiliary wall forms at least a part of a guide wall extending obliquely downward from the feed opening.

9. Assembly as claimed in claim 2, wherein the antenna has a loop shape and extends over at least practically the full width of the auxiliary wall.

10. Assembly as claimed in claim 3, wherein the antenna has a loop shape and extends over at least practically the full width of the auxiliary wall.

11. Assembly as claimed in claim 2, wherein the antenna is formed by printed circuitry on a printed circuit board.

12. Assembly as claimed in claim 3, wherein the antenna is formed by printed circuitry on a printed circuit board.

13. Assembly as claimed in claim 4, wherein the antenna is formed by printed circuitry on a printed circuit board.

14. Assembly as claimed in claim 2, wherein the valuables containers are envelopes with flat sides and the RFID element is arranged on the inner side of a flat side at a distance from the edges thereof.

15. Assembly as claimed in claim 3, wherein the valuables containers are envelopes with flat sides and the RFID element is arranged on the inner side of a flat side at a distance from the edges thereof.

16. Assembly as claimed in claim 4, wherein the valuables containers are envelopes with flat sides and the RFID element is arranged on the inner side of a flat side at a distance from the edges thereof.

17. Assembly as claimed in claim 5, wherein the valuables containers are envelopes with flat sides and the RFID element is arranged on the inner side of a flat side at a distance from the edges thereof.
